(19) United States
(12) Patent Application Publication
(10) Pub. No.: US 2008/0265530 A1
(43) Pub. Date: Oct. 30, 2008

(54) Suspension Assemblies

(76) Inventor: Juan Carlos Moliner Casani, Fleetwood (GB)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/910,917

(22) PCT Filed: Apr. 7, 2006
(86) PCT No.: PCT/GB2006/001272

§ 371 Date: Jun. 21, 2008

(30) Foreign Application Priority Data
Apr. 8, 2005 (GB) 0507134.5

(51) Int. Cl. B60G 17/005

(52) U.S. Cl. 280/5.507

(57) ABSTRACT

There are provided suspension assemblies (1) for mounting a wheel axle to a vehicle chassis. The assemblies (1) are operable between a transport configuration and a loading configuration. An assembly (1) comprises a gas spring unit (10); a frame (20) for mounting said gas spring unit to a vehicle chassis; a moveable suspension arm (30) connected or connectable to a wheel axle; and guide means arranged to restrict the gas spring unit (10) from twisting when inflated and deflated. Also provided are vehicles incorporating such assemblies.

### FIELD OF THE INVENTION

The present invention relates to suspension assemblies and to vehicles having suspension assemblies.

### BACKGROUND TO THE INVENTION

It is known to provide vehicles with pneumatic suspension assemblies which are adjustable to allow the vehicle chassis to be raised and lowered relative to a surface upon which the vehicle stands. This may be a useful feature, particularly for trailers, when it is advantageous to be able to lower the trailer deck for loading and unloading of the trailer.

One such adjustable suspension assembly is disclosed by NL1011671C and has been used in trailers for carrying motorbikes. However, a difficulty with such assemblies is that components of the gas spring unit of the assembly may be subjected to forces which tend to cause them to twist relative to one another. This may result in failure of the suspension assembly, particularly if a heavy load is transported by a trailer using such an assembly.

Accordingly, the present invention aims to address at least one disadvantage associated with known suspension assemblies whether discussed herein or otherwise.

### SUMMARY OF THE INVENTION

According to a first aspect of the present invention there is provided a suspension assembly for mounting a wheel axle to a vehicle chassis, said assembly being operable between a transport configuration, in which, in use, said chassis is supported above a surface engaged by a wheel carried by said axle and a loading configuration in which, in use, the chassis lies closer to said surface and wherein the assembly comprises:
(i) a gas spring unit comprising first and second ends moveable relative to one another and which is operable between inflated and deflated configurations;
(ii) a frame for mounting said gas spring unit to a vehicle chassis;
(iii) a moveable suspension arm connected or connectable to a wheel axle and which is pivotally mounted to the frame and coupled to the gas spring unit; and
(iv) guide means arranged to restrict the first and second ends of the gas spring unit from twisting relative to one another as the unit moves between said inflated and deflated configurations.

Suitably, the assembly is arranged such that, in use, in the loading configuration the chassis abuts a surface which is engaged by said wheel.

The frame may comprise a part of the chassis of a vehicle. The suspension arm may thus be pivotally mounted to the chassis of a vehicle.

Suitably, the guide means is arranged to guide the first and second ends of the gas spring unit to move relative to one another substantially along the axis of the gas spring unit.

Suitably, the guide means is arranged to maintain the axis of the gas spring unit in a substantially fixed position relative to the frame as the unit moves between said inflated and deflated configurations.

Suitably, the suspension assembly further comprises limit means for limiting the extent of movement of the suspension arm relative to the frame.

Preferably, the limit means limits the extent of movement of the first and second ends of the gas spring unit relative to one another.

Suitably, the assembly is such that, in use, when the gas spring unit is in an inflated configuration the suspension assembly is in a transport configuration. The inflated configuration of the gas spring unit may be defined by the limit means.

Suitably, the assembly is such that, in use, when the gas spring unit is in a deflated configuration the suspension assembly is in a loading configuration.

Suitably, the axis about which the suspension arm is mounted to the frame is arranged to extend substantially parallel to the axis of an axle to which the suspension arm is connected in use.

Preferably, the suspension arm is pivotally coupled to the gas spring unit.

Suitably, the axis about which the suspension arm is connected to the gas spring unit is arranged to extend substantially parallel to the axis of an axle to which the suspension arm is connected in use.

Suitably, the gas spring unit is mounted at a gas spring housing. Suitably, the gas spring unit is fixed to the gas spring housing at a lower end of the gas spring unit. Suitably, the gas spring unit comprises a valve. Suitably, the valve is connectable to a compressed air supply. Suitably, the gas spring unit comprises a reversible sleeve spring unit.

Suitably, the guide means is arranged to maintain an axis of a housing of the gas spring unit in a substantially fixed position relative to the frame.

The suspension assembly may be arranged to mount two substantially parallel wheel axles to a vehicle chassis. The assembly may thus be arranged to mount two wheels to a chassis. Suitably, one of said axles is arranged to lie forward of the other in use.

Suitably, the guide means is arranged to maintain an axis of the gas spring unit in a substantially fixed position relative to the frame.

The suspension assembly may comprise a first suspension arm pivotally mounted to the frame and connected, or connectable, to a first wheel axle and a second suspension arm pivotally mounted to the frame and connected, or connectable, to a second wheel axle.

Suitably, the gas spring unit is arranged to lie between the first and second wheel axles. The suspension assembly may thus be substantially symmetrical about the axis of the gas spring unit in a front to rear, in use, direction.

Suitably, the axis about which the first and second suspension arms are mounted to the frame extend generally parallel to one another. Suitably, in use, the axis about which the first and second suspension arms are mounted to the frame extend generally parallel to the axis of the axles.

The first and second suspension arms may each be pivotally coupled to the gas spring unit.

Suitably, the suspension arms are pivotally mounted to the frame in between their points of coupling to the gas spring unit and to the respective wheel axles.

Suitably, the suspension arms are orientated to lie in a front to rear direction of a vehicle in use. Suitably, the first suspension arm is arranged to be connected to a wheel on a fore side of the gas spring unit and the second suspension arm is arranged to be connected to a wheel on an aft side of the gas spring unit.

The guide means may comprise the first and second suspension arms. The suspension arms may cooperate to restrict relative twisting of the first and second ends of the gas spring unit such that said ends travel relative to one another substantially along the axis of the gas spring unit. This guiding action may be achieved due to the fact the suspension arms are coupled to the gas spring unit on opposed sides of said axis.

Suitably, the assembly comprises mounting means connected to the gas spring unit and the suspension arms. Suitably, the mounting means is arranged, in use, to extend in a front to rear direction of a vehicle and to be coupled to the first suspension arm on the fore side of the gas spring unit and to the second suspension arm on the aft side of the gas spring unit.

Suitably, the mounting means comprises a mounting arm. Suitably, the mounting arm is connected to an upper, in use, end of the gas spring unit. Suitably, the mounting arm is connected to the cradle housing of the gas spring unit.

Suitably, the mounting means is coupled to each of the suspension arms via a linkage. Each linkage is suitably pivotally connected to both a suspension arm and a mounting arm.

Suitably, one end of the gas spring unit is fixedly positioned relative to the frame.

The suspension assembly may comprise limit means which comprise a limit member mounted to the frame for abutting a suspension arm and restricting movement thereof.

Suitably, said limit member is arranged relative to the pivot point of said suspension arm with the frame such that it abuts the arm when the arm is in either a load position or a transport position. The limit means may thus define the extreme positions of the suspension arm and thus the load and transport configurations of the assembly.

The suspension assembly may comprise a limit member for each suspension arm.

Suitably, in use, the frame is arranged to move relative to both wheel axles simultaneously. Inflation of the gas spring unit may cause an upper end of the gas spring unit to move upwardly relative to the frame and thus relative to the vehicle chassis in use. Since the weight of the vehicle is suitably supported by the wheels this movement may cause the suspension arms to pivot relative to the frame and axles such that the frame and thus chassis may move upwardly relative to the wheel axles. Deflation of the gas spring unit may reverse the process.

The suspension assembly may be arranged to mount two wheel axles to a vehicle chassis and may be arranged to mount two wheels carried by the same axle to a vehicle chassis.

In alternative embodiments, the suspension assembly may be arranged to mount a single wheel axle to a vehicle chassis. Suitably, the suspension assembly may be arranged to mount a single wheel to a vehicle chassis. Alternatively, the suspension assembly may be arranged to mount two wheels carried by the same axle to a vehicle chassis.

Suitably, the guide means is arranged to maintain an axis of the gas spring unit in a substantially fixed position relative to the frame.

A first end of the suspension arm may be coupled, in use, to a wheel axle and a second end mounted to the frame of the suspension assembly.

Suitably, the suspension arm is orientated to lie in a front to rear direction of a vehicle in use.

Suitably, the gas spring unit is pivotally coupled to the suspension arm. Suitably, the gas spring unit is coupled to the suspension arm at a point lying between its mounting to the frame and coupling to a wheel axle.

Suitably, a first end of the gas spring unit is fixedly mounted to the frame.

Suitably, a second end of the gas spring unit is pivotally coupled to the suspension arm. Suitably, the gas spring unit is coupled to the suspension arm.

Suitably, the gas spring unit comprises a coupling to which the suspension arm is pivotally connected.

The suspension arm may comprise first and second branches arranged on opposed sides of the gas spring unit and which are connected to one another.

Suitably, the branches are joined by a cross-piece and each branch is pivotally mounted to the frame and pivotally coupled to the gas spring unit. This construction may provide for a strong assembly.

The guide means suitably comprises a guide arm pivotally connected to the frame and pivotally coupled to the gas spring unit.

Suitably, the guide arm is coupled to the gas spring unit at a second end thereof.

Suitably, the assembly comprises a connector arm connected to the gas spring unit at a second end thereof. Suitably, the assembly comprises a connector arm connected to the gas spring unit. The connector arm may extend either side of the gas spring unit in opposed first and second directions. Suitably, in use, said first and second directions comprise fore and aft directions. Alternatively, the assembly may comprise first and second connector arms extending in opposed first and second directions.

Suitably, the connector arm is fixedly connected to the gas spring unit and pivotally connected to the guide arm.

Suitably, the guide arm is mounted to the frame on a first side of the connection of the suspension arm and the gas spring unit and to the connector arm on a second opposed side.

Suitably, said first side comprises one of the fore and aft, in use, sides of the connection of the suspension arm and the gas spring unit and said second side comprises the other of said fore and aft sides. The guide arm may be mounted to the frame on the aft, in use, side of the connection of the suspension arm and the gas spring unit.

Suitably, the length of the guide arm is adjustable such that, in use, it can be set to accommodate for different sized wheels being mounted to the suspension assembly.

Suitably, the limit means comprises a limit arm arranged to limit extension and/or compression of the gas spring unit.

Preferably, the limit means comprises first and second limit arms.

Suitably, each limit arm comprises two or more, preferably two, pivotally connected sections.

Preferably, a first end of a first limit arm is pivotally connected to the connector arm on a first side, preferably a fore side, of the gas spring unit and suspension arm pivot point and a second end thereof is pivotally connected to the frame.

Preferably a first end of a second limit arm is pivotally connected to the connector arm on a second side, preferably an aft side, of the gas spring unit and suspension arm pivot point and a second end thereof is pivotally connected to the frame.

Suitably, the second end of the first limit arm lies closer to the first, suitably fore, side of the assembly then does the second end of the second limit arm.

Suitably, the limit arms lie on opposed sides of the gas spring unit. Suitably, the limit arms lie on inward and outward sides of the gas spring unit.

Suitably, the assembly is such that, in use, as the gas spring unit adopts an inflated configuration the sections of the limit arms rotate until the arms are substantially straight.

Suitably, the assembly is such that, in use, as the gas spring unit adopts a deflated configuration the sections of the limit arms rotate such that first end sections of the respective arms generally converge and second end sections of the respective arms generally converge.

The arrangement of two limit arms having such a “scissor like” constructions may provide some torsional rigidity to the suspension assembly. Thus, the risk of the gas spring unit twisting may be minimised when the gas spring unit has been inflated.

Suitably, in use, inflation of the gas spring unit may cause an upper end of the gas spring unit to move upwardly. Since the weight of the vehicle is suitably supported by the wheels this movement may cause the suspension arms to pivot relative to the frame and axles such that the frame and thus chassis may move upwardly relative to the wheel axles. Deflation of the gas spring unit may reverse the process.

According to a second aspect of the present invention there is provided a suspension assembly for mounting a wheel axle to a vehicle chassis, said assembly being operable between a transport configuration, in which, in use, said chassis is supported above a surface engaged by a wheel carried by said axle and a loading configuration in which, in use, the chassis lies closer to said surface and wherein the assembly comprises:
(i) a gas spring unit comprising first and second ends moveable relative to one another and which is operable between inflated and deflated configurations;
(ii) a frame for mounting said gas spring unit to a vehicle chassis;
(iii) a moveable suspension arm connected or connectable to a wheel axle and which is pivotally mounted to the frame and coupled to the gas spring unit; and
(iv) limit means for limiting the extent of movement of the suspension arm relative to the frame.

Suitably, the assembly is arranged such that, in use, in the loading configuration the chassis abuts a surface which is engaged by said wheel.

The frame may comprise a part of the chassis of a vehicle. The suspension arm may thus be pivotally mounted to the chassis of a vehicle.

Preferably, the limit means limits the extent of movement of the first and second ends of the gas spring unit relative to one another.

Suitably, in use, when the gas spring unit is in an inflated configuration the suspension assembly is in a transport configuration. The inflated configuration of the gas spring unit may be defined by the limit means.

Suitably, the assembly is such that, in use, when the gas spring unit is in a deflated configuration the suspension assembly is in a loading configuration.

Suitably, the limit means may be as described in relation to the first aspect.

Suitably, the suspension assembly further comprises guide means arranged to restrict the first and second ends of the gas spring unit from twisting relative to one another as the unit moves between said inflated and deflated configurations.

Suitably, the guide means is arranged to guide the first and second ends of the gas spring unit to move relative to one another substantially along the axis of the gas spring unit.

Suitably, the guide means is arranged to maintain the axis of the gas spring unit in a substantially fixed position relative to the frame as the unit moves between said inflated and deflated configurations.

The suspension assembly may comprise any feature as described in relation to the first aspect.

According to a third aspect of the present invention there is provided a vehicle comprising a suspension assembly according to the first or second aspect.

Suitably, the vehicle comprises a trailer. The vehicle may comprise a motorcycle trailer.

The vehicle may comprise two suspension assemblies according to the first aspect. The vehicle may comprise two suspension assemblies according to the second aspect. Suitably, the vehicle comprises two suspension assemblies which accord to both the first and second aspects.

The vehicle may comprise two single axle suspension assemblies as described in relation to the first or second aspect. Suitably, one such suspension assembly is arranged on the nearside of the vehicle and the other on the offside of the vehicle.

Alternatively, the vehicle may comprise two double axle suspension assemblies as described in relation to the first or second aspect. Suitably, one such suspension assembly is arranged on the nearside of the vehicle and the other on the offside of the vehicle.

### BRIEF DESCRIPTION OF THE DRAWINGS

The present invention will now be illustrated, by way of example with reference to the accompanying drawings in which:

FIG. 1 is a side view of a suspension assembly;

FIG. 2 is a plan view of showing the suspension assembly of FIG. 1 carrying wheels and mounted to a chassis;

FIG. 3 is a side view showing part of a suspension assembly in a transport configuration;

FIG. 4 is a side view showing part of a suspension assembly in a loading configuration;

FIG. 5 is a side view of an alternative embodiment of a suspension assembly;

FIG. 6 is a front view of the suspension assembly of FIG. 5;

FIG. 7 is a perspective view of an alternative embodiment of a suspension assembly corresponding generally to that of FIGS. 5 and 6;

FIG. 8 is a perspective view of a trailer in a load configuration;

FIG. 9 is a perspective view of part of a trailer in a transport configuration; and

FIG. 10 is a perspective view of an alternative embodiment of a suspension assembly.

### DESCRIPTION OF THE PREFERRED EMBODIMENTS

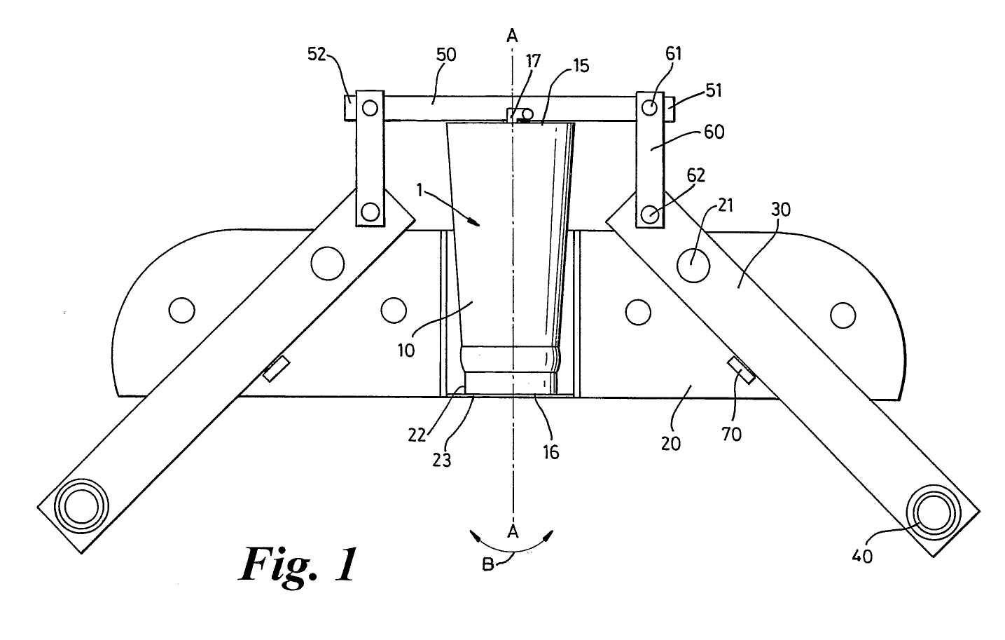

As illustrated by FIGS. 1 to 4 a suspension assembly 1 for mounting two wheel axles to a vehicle comprises a gas spring unit 10 mounted to a frame 20 and coupled to first and second suspension arms 30. The suspension arms 30 are pivotally mounted to the frame 20 about shafts 21 and coupled to wheel axles 40 which carry wheels 3.

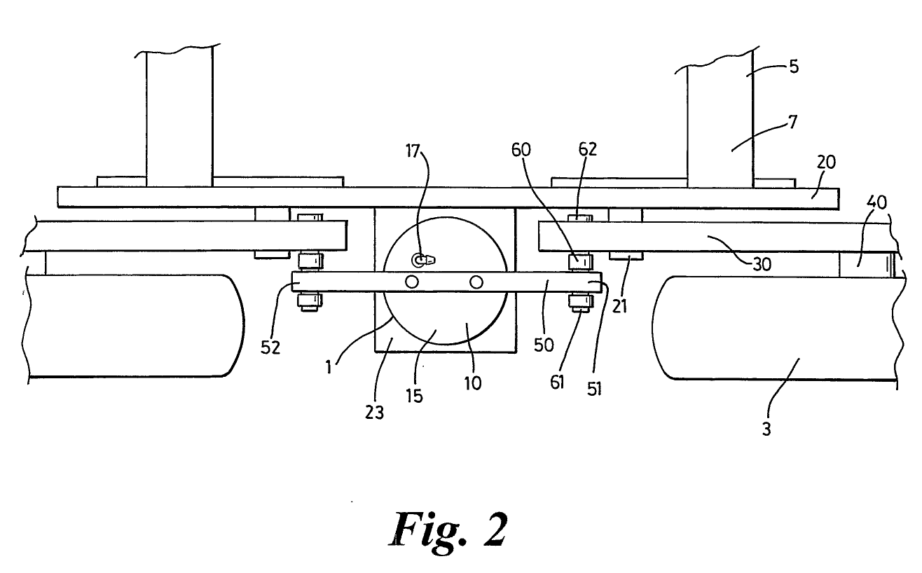

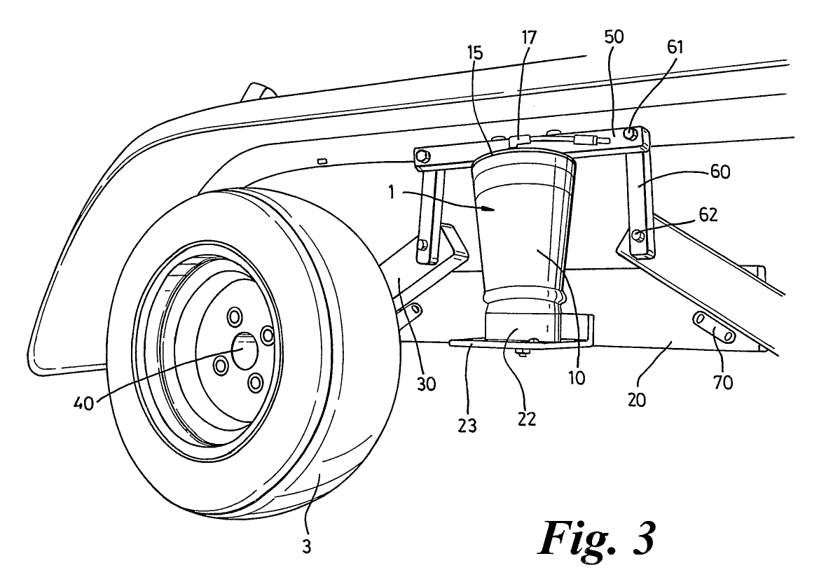

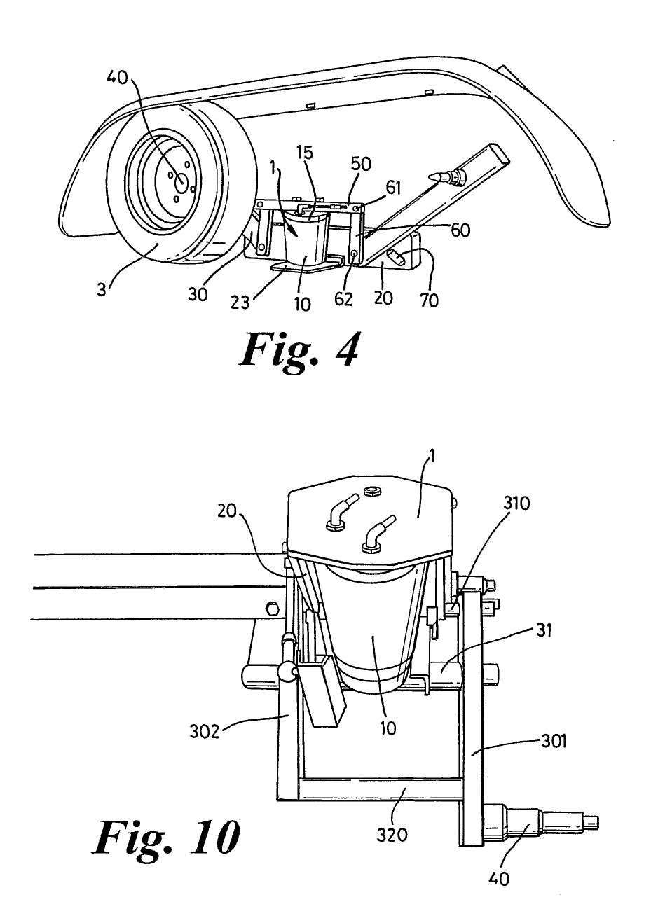

As illustrated by FIG. 2 the frame 20 is fixedly connected to the chassis 7 of a trailer 5 (only shown in part). The trailer 5 employs one assembly on the nearside and another on the off side thereof (only one side shown). Each assembly is operable between a transport configuration (FIG. 3), in which the chassis is supported above a surface engaged by the trailer 5 wheels 3, and a loading configuration (FIG. 4) in which the chassis abuts or more closely approaches said surface.

In use, the assembly 1 is moved between the transport and loading configurations by transforming the gas spring unit 10 between an inflated and deflated configurations to cause the suspension arms 30 to move.

The suspension arms 30 are arranged either side of the gas spring unit 10 such that the assembly 1 is substantially symmetrical in the front to rear direction about the axis (illustrated by line A-A) of the gas spring unit 10.

The gas spring unit 10 is in the form of a reversible sleeve spring unit. The gas spring unit comprises a first (upper) end 15 and a second (lower) end 16.

The gas spring unit 10 is operable between inflated and deflated configurations with the first and second ends 15, 16 of the gas spring unit 10 being arranged to move apart as the gas spring unit 10 is filled with air causing it to expand. If air is used to fill the gas spring unit 10 it can be described as an air spring. However, other gases or mixtures of gases may be used.

The second end 16 is fixedly connected to the frame 20 by a collar 22 and base plate 23. The first end 15 is arranged to move relative thereto and is coupled to the suspension arms 30. The assembly 1 comprises mounting means comprising a mounting arm 50 including a coupling via which the gas spring unit 10 is coupled to the suspension arms.

The mounting arm 50 is fixedly connected to the first end 15 of the gas spring unit 10 and extends either side of the gas spring unit 10 in fore and aft directions. The mounting arm 50 is pivotally connected to linkages 60 about pins 61 and each linkage 60 is in turn pivotally connected to the suspension arm 30 about a pin 62.

The connection of the linkage 60 to the suspension arm 30 lies on one side of the shaft 21 connecting the suspension arm 30 and frame 20 and the coupling of the suspension arm 30 to the axle 40 lies on the other side of the shaft 21.

The suspension arms 30 have fixed pivot points relative to the frame 20. The suspension arms are also arranged to be moved at the same time as one another by movement of the gas spring unit 10 which has the second end 16 fixed relative to the frame 20.

Thus, the suspension arms 30 can act as guide means which restrict the first and second ends 15, 16 of the gas spring unit 10 twisting relative to one another.

For the gas spring unit 10 to twist in the direction of arrows B one end 51 of the mounting arm 50 would have to be raised while the other 52 was lowered. However, the suspension arms resist such uneven movement.

Therefore, when the gas spring unit 10 is inflated and a load applied to the assembly the free end (first end 15) of the unit is unable to twist or rotate significantly relative to the fixed end (second end 16) as illustrated by arrows B. Without anything to guide the path of the free end the unit could twist in such a manner since the gas spring unit 10 is flexible.

The assembly 1 further comprises limit means arranged to limit the extent of movement of the suspension arms 30 relative to the frame 20. Each limit means comprises a limit member 70 comprising an abutment arranged to engage the suspension arm 30 when the assembly is in a loading or transport configuration.

The limit means may also limit the extent of travel of the first and second ends 15, 16 of the gas spring unit 10 relative to one another. This may minimise damage which could be caused to the assembly by over inflation of the gas spring unit 10.

In use, the gas spring units 10 of a vehicle, such as a trailer 5 can be arranged in their deflated configurations such that the suspension assemblies 1 adopt their loading configuration. The chassis 7 can thus abut the ground making it easier to load an object, such as a motorcycle, onto the vehicle or to unload a previously loaded object. The chassis 7 may be part of a transporting container for livestock, e.g. part of a horsebox. Lowering of the chassis may in this case reduce problems associated with leading livestock up a ramp into a transporting container.

Once loaded the gas spring units 10 can be supplied with compressed air, another gas or mixture of gases via valve 17 to pressurize them and to cause them to move to their inflated configuration. This inflation causes the first and second ends 15, 16 of the unit 10 to move apart which thus causes the suspension arms 30 to pivot relative to the frame 20. This in turn causes the frame 20 to move upwardly relative to the wheel axles 40. The suspension assembly 1 thus moves to a transport configuration in which the chassis 7 is held clear of the ground.

To unload a vehicle the above process can be substantially reversed by releasing air from the gas spring 10 via valve 17.

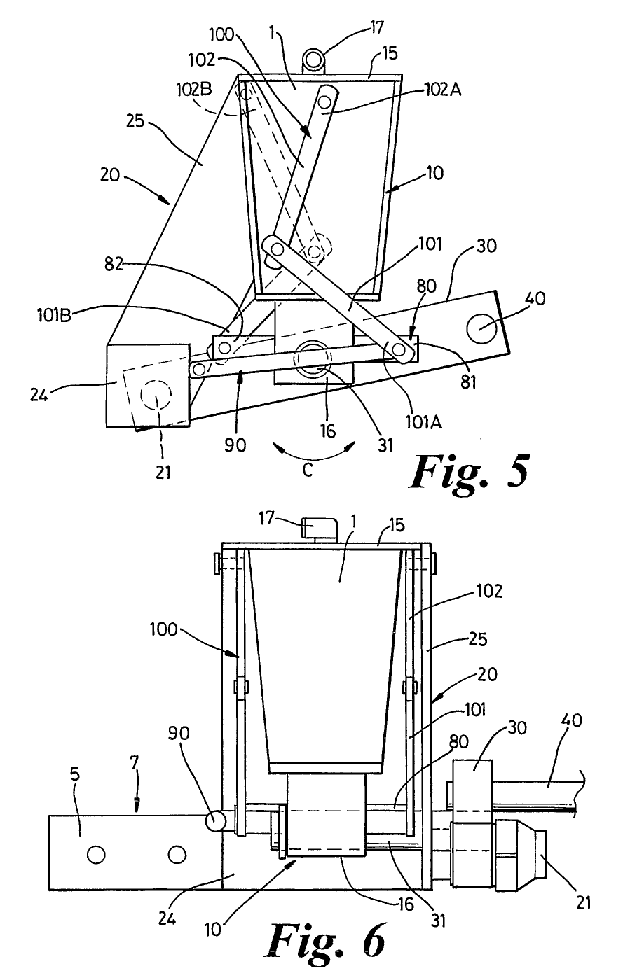

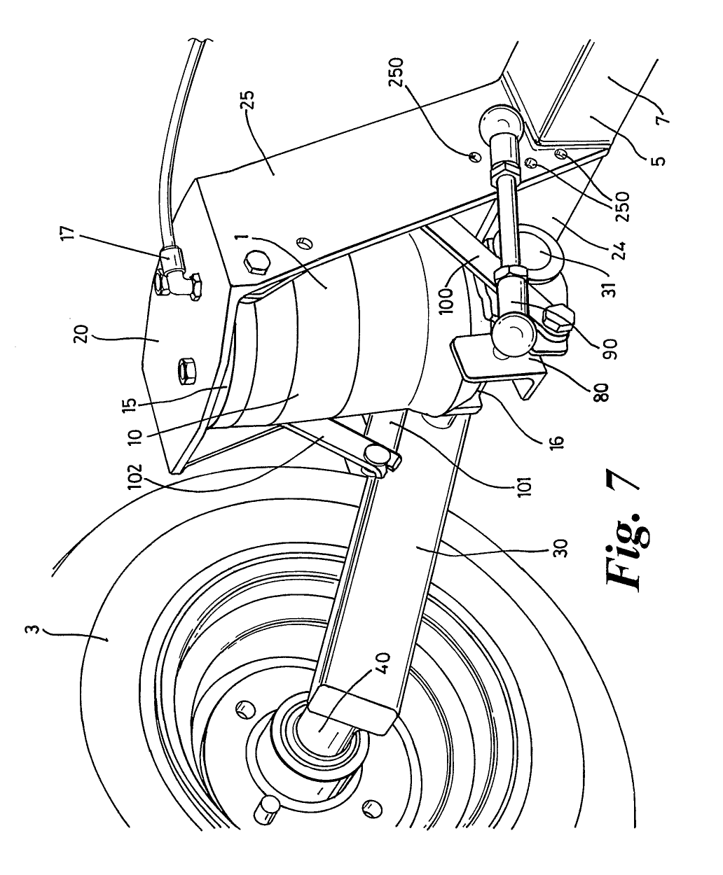

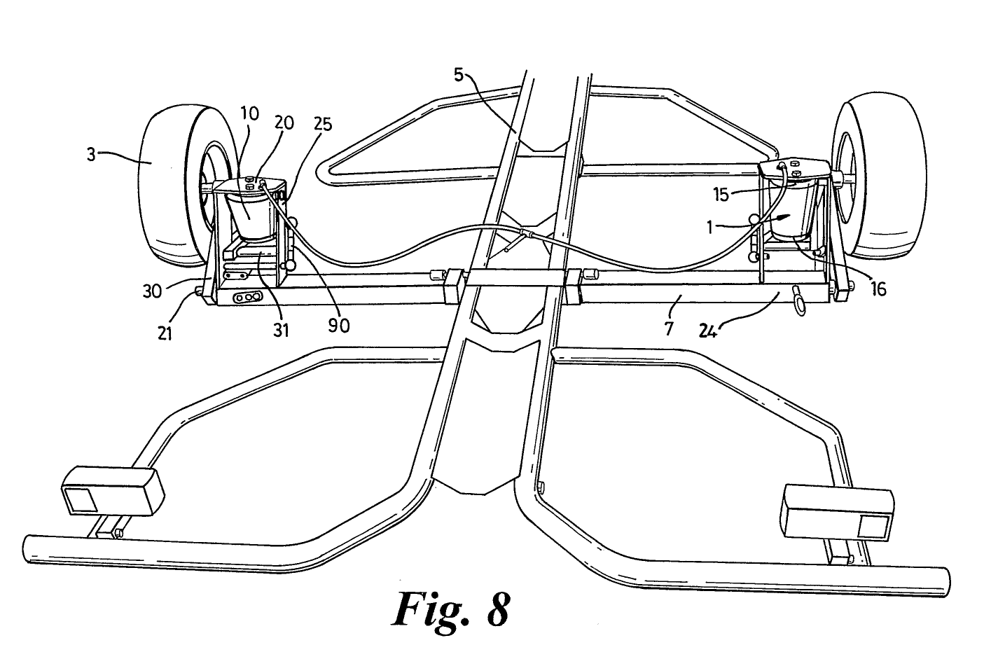

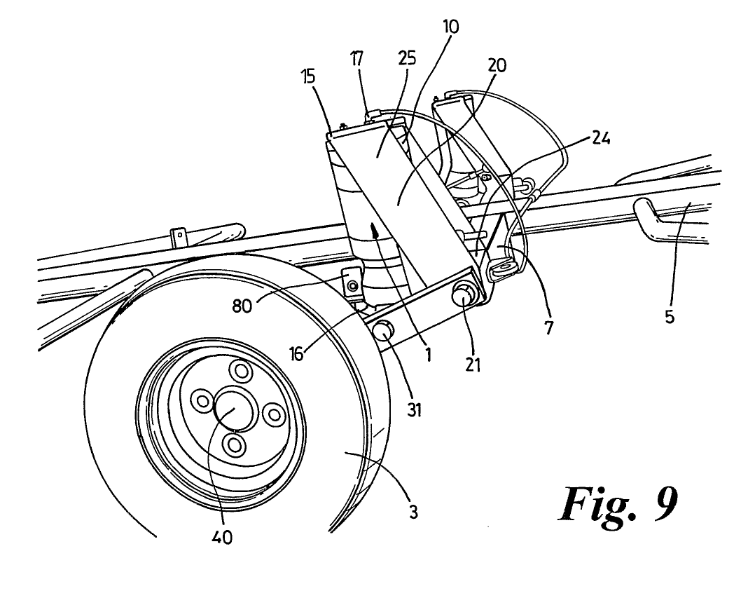

FIGS. 5 and 6 illustrate an alternative embodiment of a suspension assembly 1. FIGS. 7 to 9 show a still further embodiment of a suspension assembly 1 which differs in only minor construction details from that of FIGS. 5 and 6; thus the two embodiments are referred to collectively herein. Like the first embodiment, these assemblies also employ guide means to resist twisting of a gas spring unit 10 and limit means to control the travel of a suspension arm 30. Many of the other features are also the same as those of the first embodiment and like parts are labelled accordingly. The main distinction is that this assembly 1 is arranged to mount a single wheel axle to a vehicle chassis.

The assembly 1 comprises a gas spring unit 10 mounted to a frame 20 and coupled to a suspension arm 30. The suspension arm 30 is pivotally mounted to the frame 20 about shaft 21 and coupled to a wheel axle 40 which carries a wheel 3.

FIGS. 7 to 9 illustrate the frame 20 fixedly connected to the chassis 7 of a vehicle which comprises a trailer 5. The frame 20 comprises a main beam 24 which also serves as part of the chassis 7. Thus, the suspension assembly frame 20 comprises an integral part of the trailer chassis 7. The trailer 5 employs one assembly on the nearside and another on the off side thereof. Each assembly is operable between a transport configuration, in which the chassis 7 is supported above a surface engaged by the trailer 5 wheels 3, and a loading configuration in which the chassis 7 abuts said surface.

In use, as with the first embodiment the assembly 1 is moved between the transport and loading configurations by transforming the gas spring unit 10 between an inflated and deflated configuration to cause the suspension arm 30 to move.

The gas spring unit 10 comprises a first (upper) end 15 and a second (lower) end 16.

The gas spring unit 10 is operable between inflated and deflated configurations with the first and second ends 15, 16 of the unit 10 being arranged to move apart as the gas spring unit 10 is filled with air causing it to expand.

A gas spring housing supports the first end 15 and is fixed to frame members 25 which extend upwardly from the main beam 24. The second end 16 is arranged to move relative to the gas spring housing and frame 20 and is pivotally coupled to the suspension arm 30 about a shaft 31.

The connection of the frame 20 to the suspension arm 30 lies on one side of the shaft 31 connecting the suspension arm 30 and gas spring unit 10 and the coupling of the suspension arm 30 to the wheel axle 40 lies on the other side of the shaft 31.

The assembly 1 further comprises connection arms 80 fixedly connected to the gas spring unit 10 and extending either side thereof the gas spring unit 10 generally in fore and aft directions.

A guide arm 90 is pivotally connected to the frame 20 on an aft side of the shaft 31 and to a connection arm 80 on a fore side of the shaft 31.

When the gas spring unit 10 is inflated and a load applied to the assembly the free end (second end 16) of the unit may tend to twist or rotate relative to the fixed end (first end 15) about the axis of shaft 31 as illustrated by arrows C unless restrained and guided in some way. The path of the free end the unit 10 could twist in such a manner since the gas spring unit 10 is flexible.

However, the guide arm 90 provides a guide means which guides rotation of the connection arm 80. The guide arm may thus restrict the first and second ends 15, 16 of the gas spring unit 10 twisting relative to one another.

For the gas spring unit to twist in the direction of arrows C the end 81 of one connector arm 80 would have to be raised while the end 82 of the other was lowered. However, the guide arm 90 may resist such uneven movement when the gas spring unit 10 has been at least partially inflated.

The length of the guide arm 90 and position of the end thereof on the frame member 25 is adjustable so that it can be set to provide minimal twisting of the unit 10 dependent on the wheel size employed with the assembly 1. The guide arm 90 may be secured on the frame member 25 at one of a number of predetermined positions, with the length and fixing position thereof determining the guided path. Apertures 250 of FIG. 7 are examples of other predetermined positions at which the guide arm 90 could be secured on the frame member 25. More apertures could be provided in the frame member 25 above those shown in FIG. 7.

The assembly 1 further comprises limit means arranged to limit the extent of movement of the suspension arm 30 relative to the frame 20.

The limit means comprises limit arms 100 pivotally connected to the frame and to the connector arms 90 and arranged on opposed inward and outward sides of the gas spring unit 10.

Each limit arm 100 comprises two sections 101, 102 pivotally connected to one another. A first, lower, end 101A of a first limit arm is pivotally connected to a connector arm 80 on a fore side of the shaft 31 and a second, upper, end 102A thereof is pivotally connected to the frame 20. A first, lower, end 101B of a second limit arm is pivotally connected to a connector arm 80 on an aft side of the shaft 31 and a second, upper, end 102B thereof is pivotally connected to the frame 20. The limit arms 100 are arranged such that the second end 102A of the first limit arm lies closer to the fore side of the assembly 1 then does the second end 102B of the second limit arm.

The limit means also limit the extent of travel of the first and second ends 15, 16 of the gas spring unit 10 relative to one another. This may minimise damage which could be caused to the assembly by over inflation of the gas spring unit 10.

In use, the sections 101, 102 of the limit arms 100 can rotate relative to one another as the gas spring unit 10 is inflated until their ends lie at the maximum separation at which point they restrict further movement of the second end 16 of the gas spring unit 10 relative to the frame 20. Thus, movement of the suspension arm 30 relative to the frame 20 is also limited.

The operation of the assembly 1 corresponds generally to that described in relation to the first embodiment. The gas spring unit 10 is pressurised as required by supplying or releasing air through valve 17 to transform the gas springs configuration. This in turn causes the suspension arm 30 to pivot relative to the frame 20 thus moving the vehicle axle 40 relative to the frame 20.

FIG. 10 illustrates an alternative embodiment of a suspension assembly 1. The assembly 1 generally corresponds to that of FIGS. 7 to 9 but differs in that the suspension arm 30 comprises first and second branches 301, 302 on opposed sides of the gas spring unit 10.

Each branch 301, 302 is pivotally mounted to the frame 20 by a rod 310 which also serves as a cross-piece connecting the branches 301, 302. The branches 301, 302 are also pivotally coupled to the gas spring unit 10 by shaft 31 and joined to one another by a cross-piece 320. The first branch 301 also carries a wheel axle 40.

This construction provides a stronger and more rigid assembly but otherwise the suspension assembly 1 operates in the same manner as that of FIGS. 5 and 6 and FIGS. 7 to 9.

The assemblies described herein may be incorporated into a trailer on manufacture, or may be retrofitable to existing trailers as replacement suspension. To increase ease of incorporation with existing trailers the assembly may be supplied welded or otherwise coupled to a beam or other mounting structure, with the mounting structure provided with bolt-holes or other fixing features compatible with existing trailer suspension mounting points.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A suspension assembly for mounting a wheel axle to a vehicle chassis, said assembly being operable between a transport configuration, in which, in use, said chassis is supported above a surface engaged by a wheel carried by said axle and a loading configuration in which, in use, the chassis lies closer to said surface and wherein the assembly comprises:
(i) a gas spring unit comprising first and second ends moveable relative to one another and which is operable between inflated and deflated configurations;
(ii) a frame for mounting said gas spring unit to a vehicle chassis;
(iii) a moveable suspension arm connected or connectable to a wheel axle and which is pivotally mounted to the frame and coupled to the gas spring unit; and
(iv) guide means arranged to restrict the first and second ends of the gas spring unit from twisting relative to one another as the unit moves between said inflated and deflated configurations.

2. An assembly according to claim 1, wherein the suspension assembly further comprises limit means for limiting the extent of movement of the suspension arm relative to the frame.

3. An assembly according to claim 1 or 2, wherein the axis about which the suspension arm is mounted to the frame is arranged to extend substantially parallel to the axis of an axle to which the suspension arm is connected in use.

4. An assembly according to any preceding claim, wherein the axis about which the suspension arm is connected to the gas spring unit is arranged to extend substantially parallel to the axis of an axle to which the suspension arm is connected in use.

5. An assembly according to any preceding claim, wherein the suspension assembly is arranged to mount two substantially parallel wheel axles to a vehicle chassis.

6. An assembly according to claim 5, wherein the suspension assembly comprises a first suspension arm pivotally mounted to the frame and connected, or connectable, to a first wheel axle and a second suspension arm pivotally mounted to the frame and connected, or connectable, to a second wheel axle and wherein the gas spring unit is arranged to lie between the first and second wheel axles.

7. An assembly according to claim 6, wherein the guide means comprises the first and second suspension arms.

8. An assembly according to claim 6 or 7, wherein the assembly comprises mounting means connected to the gas spring unit and the suspension arms.

9. An assembly according to any of claims 5 to 8, wherein the suspension assembly comprises limit means which comprise a limit member mounted to the frame for abutting a suspension arm and restricting movement thereof.

10. An assembly according to any one of claims 1 to 4, wherein the suspension assembly is arranged to mount a single wheel axle to a vehicle chassis.

11. An assembly according to claim 10, wherein the suspension arm is orientated to lie in a front to rear direction of a vehicle in use.

12. An assembly according to claim 10 or 11, wherein the gas spring unit is coupled to the suspension arm at a point lying between its mounting to the frame and coupling to a wheel axle.

13. An assembly according to any of claims 10 to 12, wherein the guide means comprises a guide arm pivotally connected to the frame and pivotally coupled to the gas spring unit.

14. An assembly according to any of claims 10 to 13, wherein the assembly comprises a connector arm connected to the gas spring unit.

15. An assembly according to claim 14, wherein the connector arm is fixedly connected to the gas spring unit and pivotally connected to the guide arm.

16. An assembly according to any of claims 10 to 15, wherein the length of the guide arm is adjustable such that, in use, it can be set to accommodate for different sized wheels being mounted to the suspension assembly.

17. An assembly according to any of claims 10 to 16, wherein the assembly comprises limit means which comprises a limit arm arranged to limit extension and/or compression of the gas spring unit.

18. An assembly according to claim 17, wherein the limit means comprises first and second limit arms and each limit arm comprises two or more, pivotally connected sections.

19. A suspension assembly for mounting a wheel axle to a vehicle chassis, said assembly being operable between a transport configuration, in which, in use, said chassis is supported above a surface engaged by a wheel carried by said axle and a loading configuration in which, in use, the chassis lies closer to said surface and wherein the assembly comprises:
(i) a gas spring unit comprising first and second ends moveable relative to one another and which is operable between inflated and deflated configurations;
(ii) a frame for mounting said gas spring unit to a vehicle chassis;
(iii) a moveable suspension arm connected or connectable to a wheel axle and which is pivotally mounted to the frame and coupled to the gas spring unit; and
(iv) limit means for limiting the extent of movement of the suspension arm relative to the frame.

20. An assembly according to claim 19, wherein the suspension assembly further comprises guide means arranged to restrict the first and second ends of the gas spring unit from twisting relative to one another as the unit moves between said inflated and deflated configurations.

21. An assembly according to claim 19 or 20, wherein the suspension assembly comprises an assembly according to any of claims 1 to 18.

22. A vehicle comprising a suspension assembly according to any of claims 1 to 21.

23. A vehicle according to claim 22, wherein the vehicle comprises a trailer.
